(19) United States
(12) Patent Application Publication
(10) Pub. No.: US 2005/0278773 A1
(43) Pub. Date: Dec. 15, 2005

(54) Method and system for creating a virtual television network

(75) Inventors: Donald DeCinque, Audubon, NJ (US); Joseph M. Murphy, Mount Laurel, NJ (US)

Correspondence Address: Daniel H. Golub;Margan, Lewis & Bockius LLP, 1701 Market Street, Philadelphia, PA, 19103-2217, US

(73) Assignee: Telvue Corporation, Mount Laurel, NJ (US)

(21) Appl. No.: 11/190,363

(22) Filed: Jul. 27, 2005

Related U.S. Application Data
(63) Continuation-in-part of application No. 10/630,242, filed on Jul. 30, 2003.
(60) Provisional application No. 60/485,478, filed on Jul. 8, 2003.

(51) Int. Cl. H04N 7/16; G06F 17/00; G06F 15/00; H04N 7/173

(52) U.S. Cl. 725/138; 715/500.1; 715/501.1; 715/513; 715/523

(57) ABSTRACT

A method for creating content and accessing content for publication of the content over a communication media selected from the group consisting of audio media, video media and audio-video media. A graphical user interface is provided allowing a plurality of users to create content or access assembled content through a common web site. The created content and assembled content is stored in a library located at a web server. A user, associated with a channel, selects content from the library and schedules the content for broadcast over a channel. The content is broadcast as a video signal over a channel, displayed on a web site, affiliated with the channel, as a web page and/or broadcast as an audio signal over a radio channel.

This application is a continuation-in-part of U.S. patent application Ser. No. 10/630,242, filed Jul. 30, 2003, which claims the benefit of U.S. Patent Application No. 60/485,478, filed Jul. 8, 2003.

### FIELD OF THE INVENTION

The present invention is directed to method and system for creating content and for accessing content for publication of the content over a communication media selected from the group consisting of audio media, video media and audio-video media.

### BACKGROUND OF THE INVENTION

At present, many cable television systems include a government access channel, which broadcasts messages to the subscribers served by each particular cable system. In many cases, the quality of the content presented on the government access channels is unsophisticated, and not current. This situation is due in large measure to the high cost typically associated with generating broadcast-quality content, and the fact that most government access channels have limited financial resources to spend for generating content. The present invention provides a solution to this problem, by offering local municipalities a low-cost system for generating and constantly updating high quality content for broadcast on government access channels. It will be readily apparent that the invention also has applicability beyond government access channels, and may be readily employed in other broadcasting environments where low-cost, high quality video content is desired.

### SUMMARY OF THE INVENTION

The present invention provides for a method for creating content for publication of the content over a communication media selected from the group consisting of audio media, video media and audio-video media. A graphical user interface is provided that allows a plurality of users to create content, wherein the plurality of users access said graphical user interface through a common web site. A first content, is created by a first user, using applications accessible through the internet via the graphical user interface, wherein said first content is comprised of at least one of a first single content screen or a first series of content screens. The first single content screen is created by the user including at least one of the following steps: defining a first picture size; entering a first text; inserting a first visual from a first visual source; inserting a first video from a first video source; inserting a first audio from a first audio source; and assembling the first content screen in a digital format. The steps are optionally repeated by the first user, in order to form the first series of content screens. The first content, created by the first user, is scheduled for broadcast over a channel, associated with the first user, wherein said channel comprises at least one of a cable channel or a video network. The first content, created by the first user, is delivered to a player and then broadcast as a video signal over the channel, associated with the first user, in accordance with the scheduling performed by the first user. A second user, via the graphical user interface, may create and schedule content for broadcast as a video signal over a channel, wherein the first user is not affiliated with the second user. The content is replicated and delivered to a library at a web server via the internet. The user, via the graphical user interface, selects the replicated content from the library. A web site affiliated with the cable channel, associated with the user, is provided wherein a homepage of the affiliated web site includes a hyperlink to an associated web page. The replicated content, selected by the user, is fetched from the web server by clicking the hyperlink to the associated web page and then displayed on the associated web page. The replicated content, selected by the user, may also be sent from the web server, to a text to speech converter which converts the replicated content to an audio message. Via the graphical user interface, the audio message is scheduled for broadcast over a radio channel, associated with the user. The audio message is broadcast as an audio signal over a radio channel, associated with the user, in accordance with the scheduling performed by the user.

The present invention is further directed to a method for accessing content for publication of the content over a communication media selected from the group consisting of audio media, video media and audio-video media. Assembled content, stored in a library at a web server, is provided wherein said assembled content is comprised of at least one of a single assembled content screen or a series of assembled content screens. The assembled content comprises at least one of visual information, video information and audio information. A graphical user interface is provided that allows a plurality of users to access assembled content, wherein the plurality of users access said graphical user interface through a common web site. A first user selects, via the graphical user interface, an assembled content from the library. The first user schedules, via the graphical user interface, the assembled content, selected by the first user, for broadcast over a channel, associated with the first user, wherein said channel comprises at least one of a cable channel or a video network. The assembled content, selected by the first user, is sent, from the web server via the internet, to a player. The assembled content, selected by the first user, is broadcast as a video signal over the channel, associated with the first user, in accordance with the scheduling performed by the first user. A second user, via the graphical user interface, may select and schedule, for broadcast as a video signal over a channel, assembled content from the library, wherein the first user is not affiliated with the second user. A web site is further provided having a homepage which includes a hyperlink to an associated web page, wherein the web site is affiliated with the cable channel which is associated with the user. The assembled content, selected by the user, is fetched from the web server by clicking the hyperlink to the associated web page and then displayed on the associated web page. The assembled content, selected by the user, may also be sent from the web server, to a text to speech converter, which is converted to an audio message. The audio message is scheduled for broadcast as an audio signal and then broadcast over the radio channel, associated with the first user, in accordance with the scheduling performed by the first user.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1 illustrates a system used in connection with the present invention;

FIGS. 2A-2E illustrate an exemplary graphical user interface that may be used for creating content in connection with the present invention;

FIGS. 3A-3B illustrate an exemplary graphical user interface that may be used for selecting and scheduling content for display as a video signal over a channel, as a web page or broadcast as a text message over a radio channel;

FIGS. 4A-4D illustrate an exemplary graphical user interface that may be used for selecting and scheduling assembled content for display as a video signal over a channel, as a web page or broadcast as a text message over a radio channel;

FIGS. 5A-5B illustrate an exemplary graphical user interface that may be used for selecting and scheduling content for display as a web page or broadcast as a text message over a radio channel;

FIGS. 6A-6C illustrate an exemplary graphical user interface that may be used for creating an alert in connection with the present invention;

FIG. 7 is a flow chart illustrating a method of a preferred embodiment of the present invention;

FIG. 8 is a flow chart illustrating a method of a preferred embodiment of the present invention;

FIG. 9 is a flow chart illustrating a method of a preferred embodiment of the present invention; and

FIG. 10 is a flow chart illustrating a method of a preferred embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

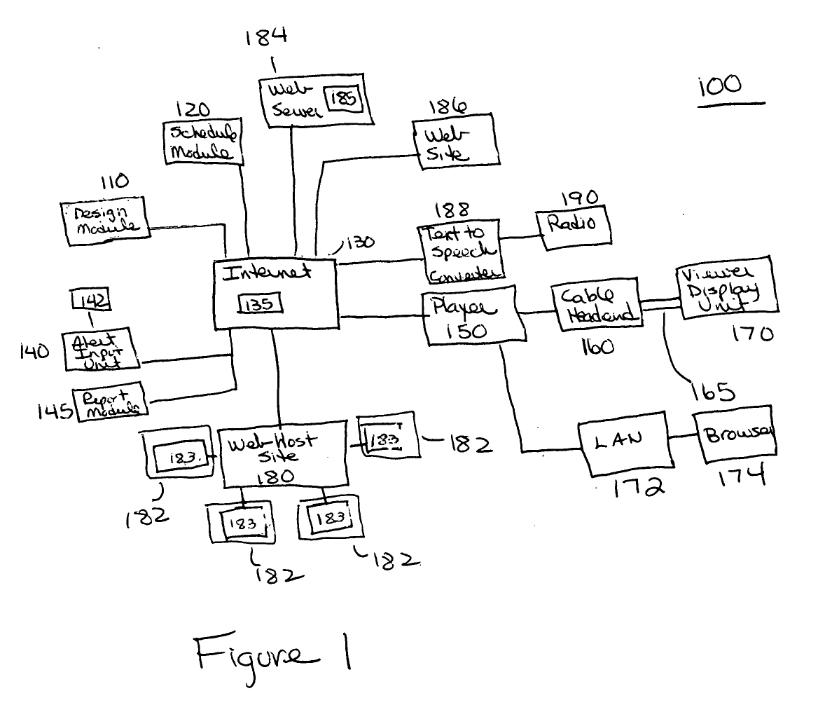

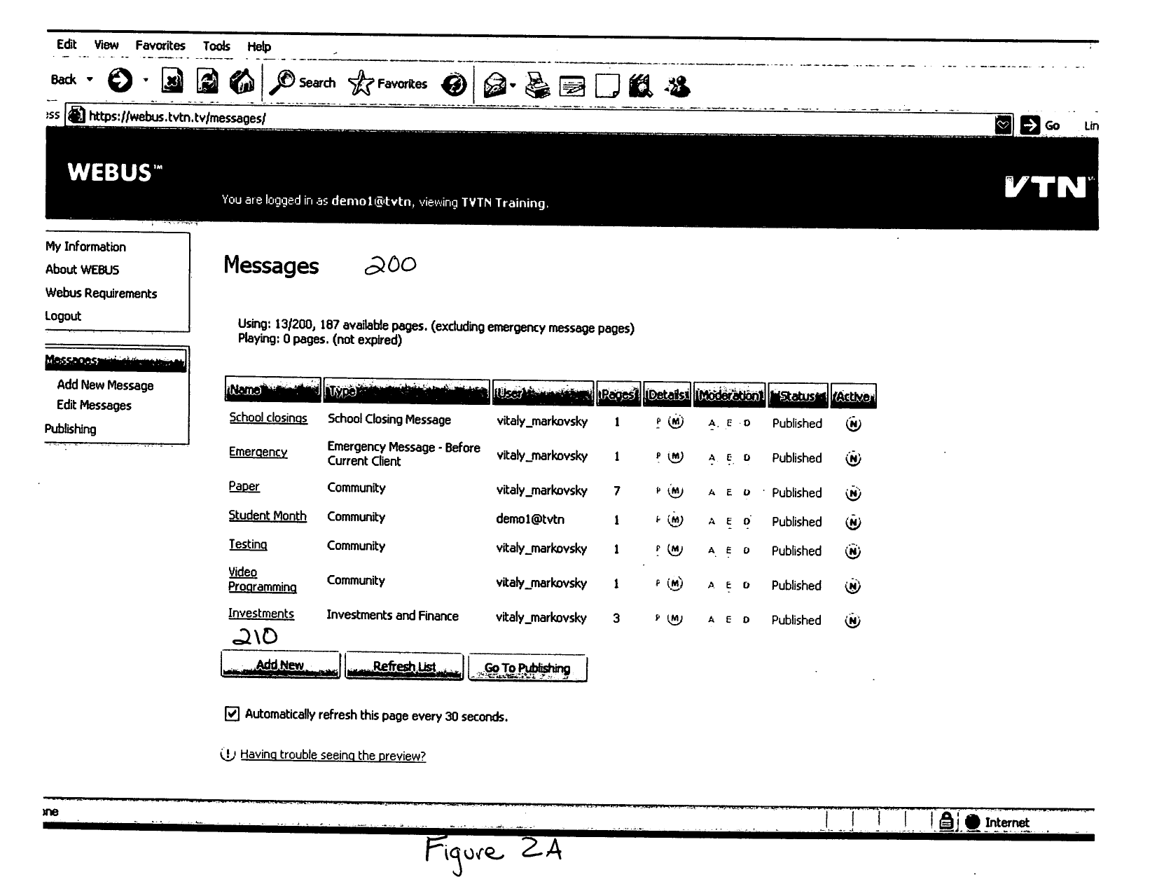

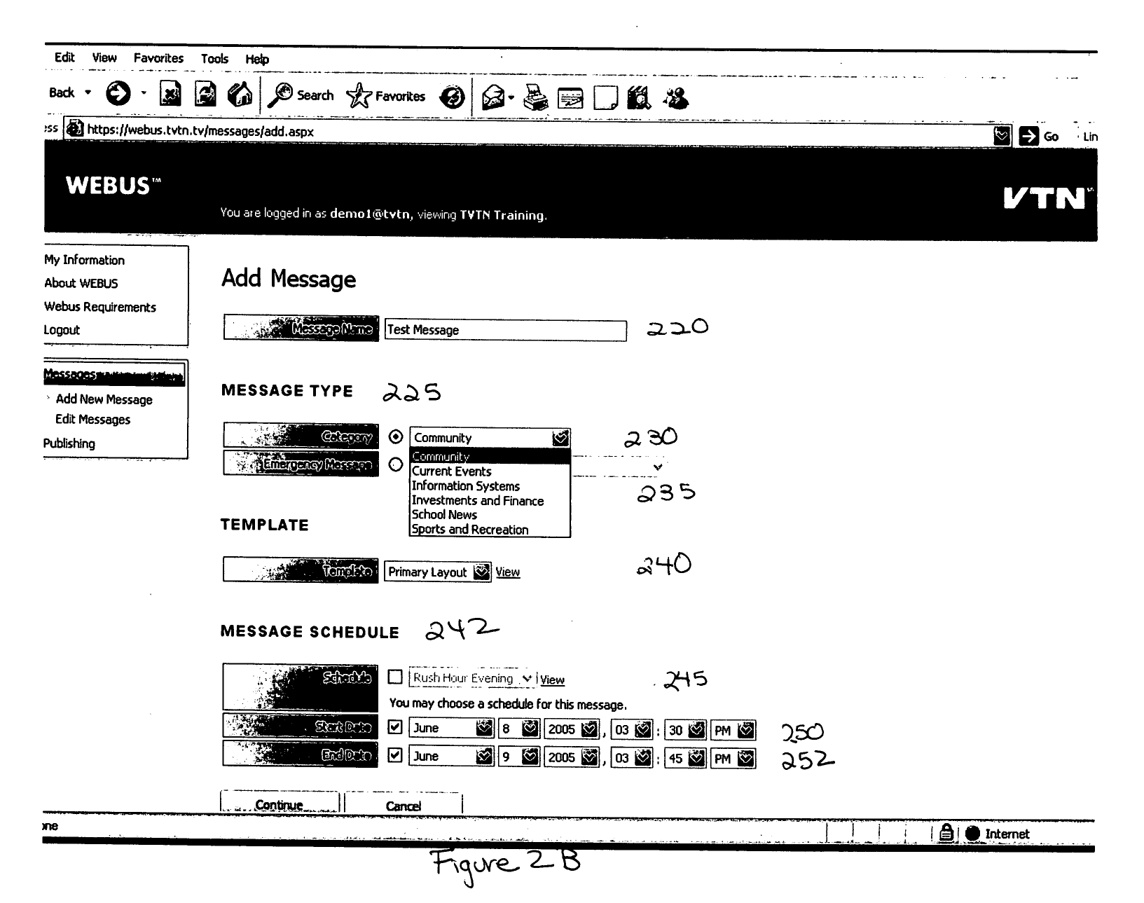

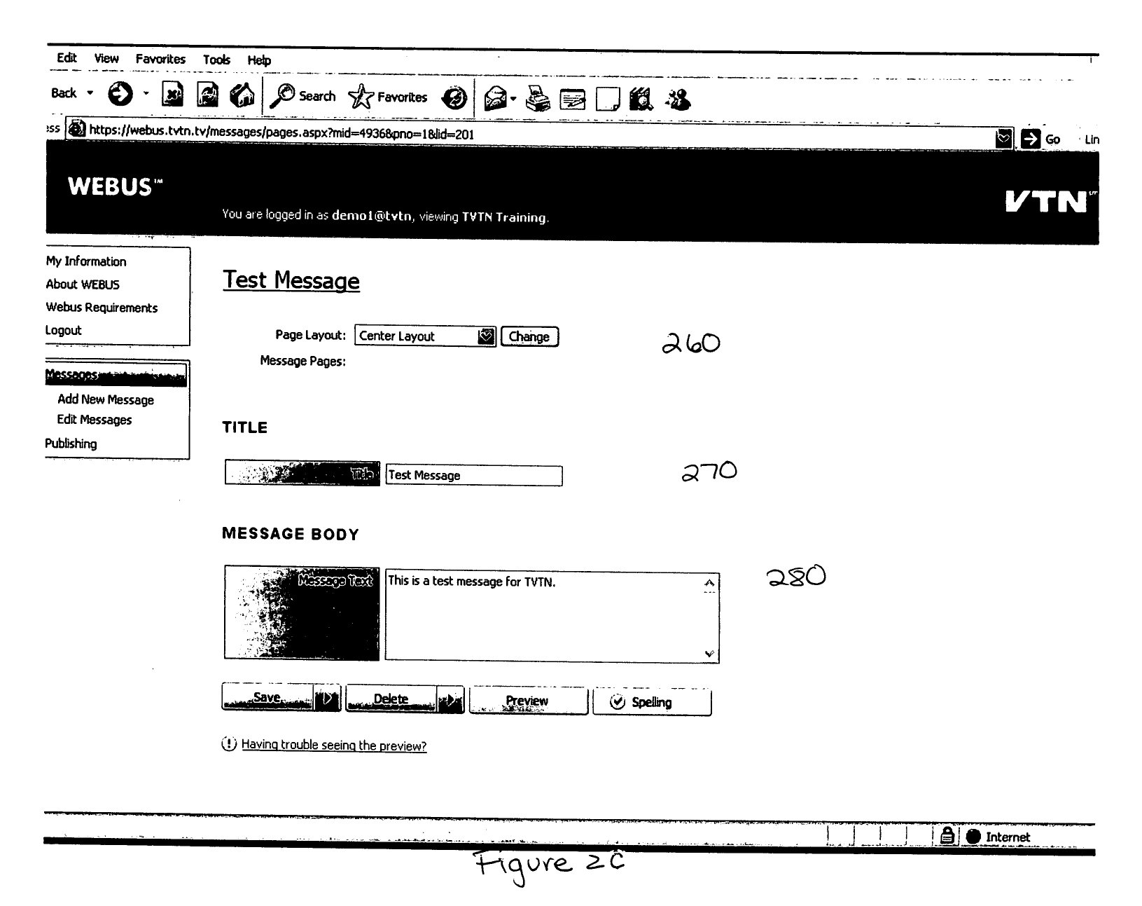

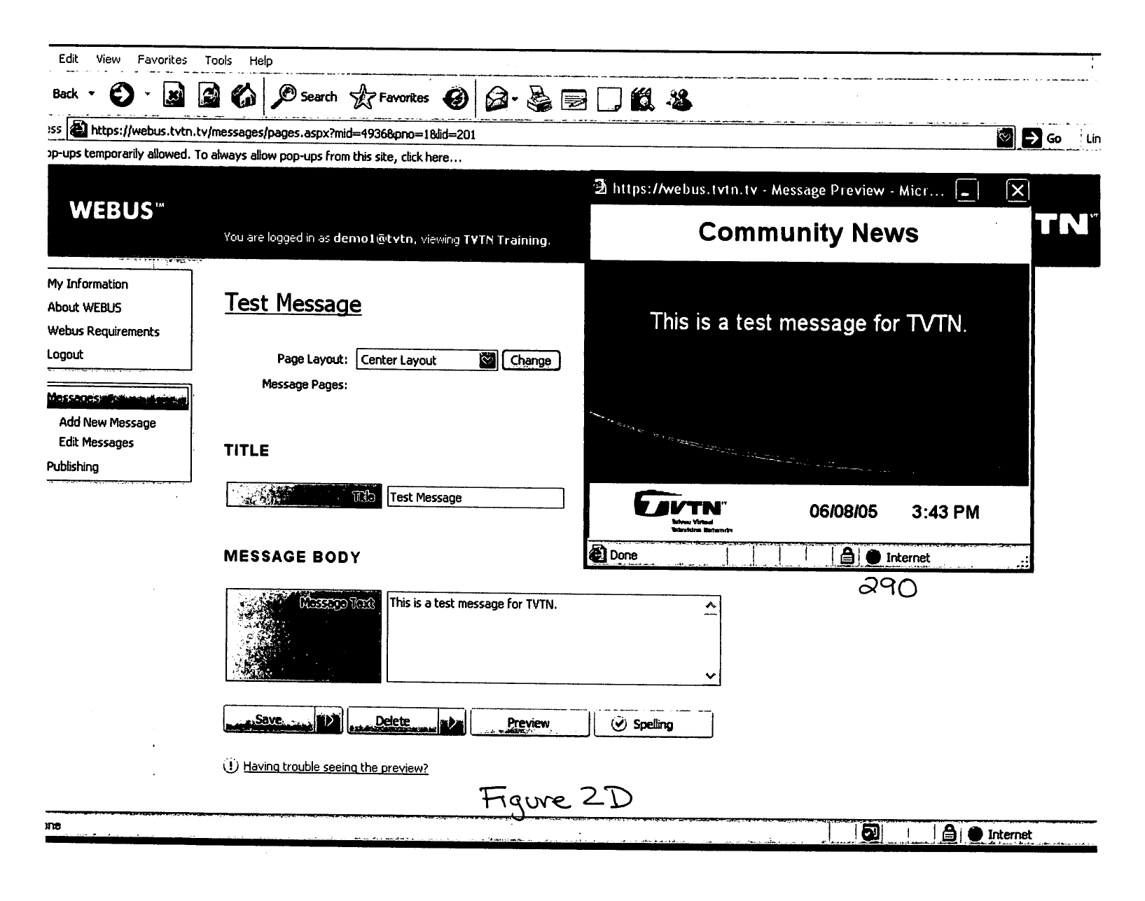

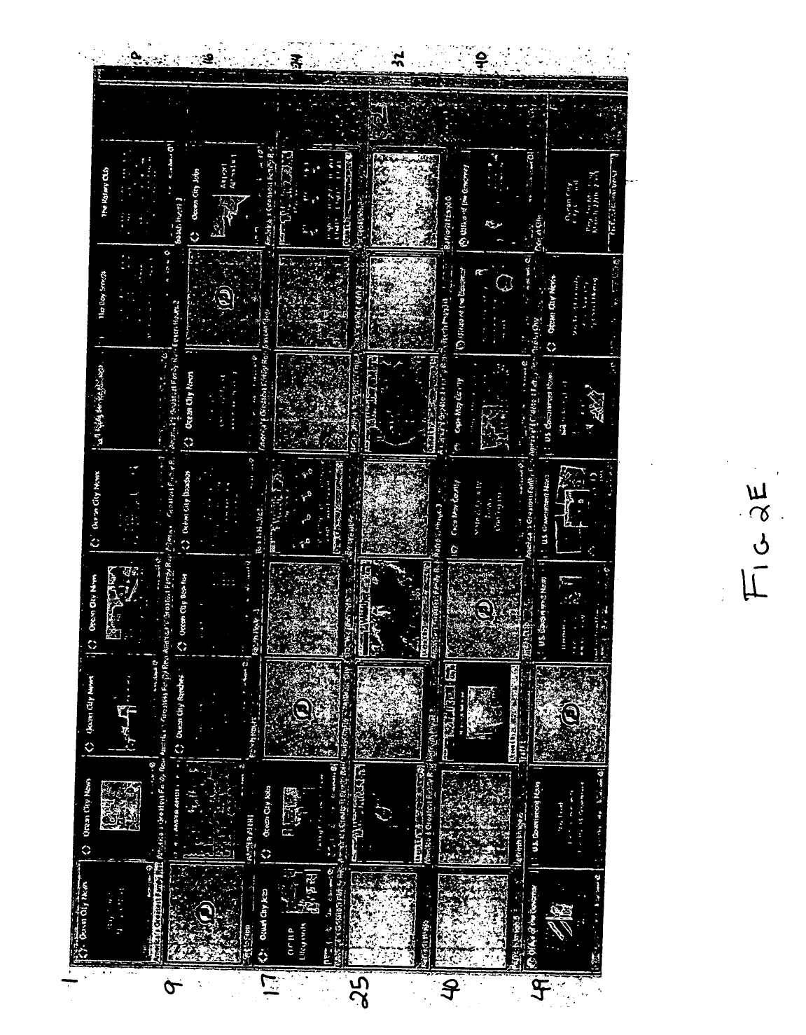

FIG. 1 illustrates system 100 that may be used to carry out the methods of the present invention. System 100 includes design module 110, schedule server 120, internet 130, on-line content source 135, alert input unit 140, graphical user interface 142 (“GUI2”), reporter module 145, player 150, cable headend 160, a channel 165, viewer display units 170, a local area network (“LAN”), via a LAN interface, 172 a browser 174, a web hosting site 180, a plurality of user devices 182, graphical user interface 183 (“GUI”), a web server 184, a library 185, a channel affiliated web site 186, a text to speech converter 188 and a radio channel 190. The channel 165 may be comprised of a cable channel or video network such as a local area network. The user may view the content via a viewer display unit 170 such as a television or a monitor displaying a browser. The applications of the design module 110, schedule server 120, reporter module 145, and player 150 are accessible to a plurality of users through GUI 183 wherein the plurality of users access GUI 183 through a common web host site 180 via the internet 130. The design module 110 allows the users to create content having a variety of multimedia elements. The schedule server 120 allows the users to schedule the time and date for transmission of the content to the player 150. Text messages are created at the reporter module 145. The created content is also replicated and stored in library 185 located at web server 184. Library 185 also stores assembled content such as public service announcements. The library 185 is accessible to the users via GUI 183. The user may access the content, via GUI 183, for broadcast over a channel 165, display at a web site 186 or broadcast over a radio channel 190. The channel 165 may have an affiliated web site 186 or radio channel 190. Alert messages are created at the alert input unit 140 using GUI2 142 and then forwarded through the internet 130, to a player 150. After a user creates content, it is delivered from the design module 110 through the internet 130, to player 150 located optionally at a cable system provider or a client location. Player 150 also fetches updated content and alerts via the internet 130 from the on-line content source 135 and then forms an updated content screen or an alert using the content from the on-line content source. In one preferred embodiment, player 150 outputs the content and alerts to cable headend 160 that broadcasts the content as a video signal over channel 165 for viewing on a viewer display unit 170. In a second preferred embodiment, player 150 outputs the content and alerts to a LAN 172 for viewing via a browser 174. Although the system shown in FIG. 2 includes hardware for generating and broadcasting content over a single channel, it will be understood to those skilled in the art that similar systems could be employed at a plurality of different cable systems each with, e.g., it own government access channel having different content, and that on-line content source 135 could be used via the internet to simultaneously update content, e.g., provide an alert, on all such government access channels. In one embodiment, software available from Scala™, Inc. is used to implement design module 110, schedule server 120, reporter module 145, and player 150.

In one embodiment of the present invention, a method is provided for creating content for publication of the content over a communication media selected from the group consisting of an audio media, a video media and an audio-video media. A plurality of users may create content by accessing the GUI 183 via the common web site 180. Each user is associated with a channel and each channel may have a plurality of associated users. More than one user may access the GUI 183 at a given time and the more than one user may be associated with the same channel or a different channel wherein a first user creates a first content and a second user creates a second content. The plurality of users access applications, located at the design module 110, via GUI 183, to create content. The user may create a single content screen or a series of content screen by assembling a plurality of the individual content screens into a series of screens.

An exemplary illustration of creating a content screen, by a single user associated with a channel, is illustrated in FIGS. 2A-2D. The user creates the content screen through a series of optional input steps depending on the type of multimedia elements the user will add to the content screen. In one embodiment, a user may create a content screen which displays a message. Via GUI 183, the user accesses the message screen 205, and creates a new message by clicking the Add New button 210, FIG. 2A. Next the user enters the message name 220, the type of message 225, selects the message template 240 and the message schedule 242. Preferred embodiments of the message type 225 include emergency messages 235 or messages selected from a drop down menu 230 including community, current events, information systems, investments and finance, school news and sport and recreation. The user may select the message schedule, e.g., day and section of the day, from a drop down menu 245 or enter the start date 250 and end date 252, as shown in FIG. 2B. The user may then select the layout for the message from a drop down menu 260 of layout choices, enter the message title 270 and the message text 280, FIG. 2C. The various elements of the content screen are then assembled to complete the screen which is converted to digital form. As shown in FIG. 2D, the completed content screen 290 is shown with the message displayed over an artistic background. The user optionally repeats these steps to create a plurality individual content screens. The individual content screens are finally assembled to form a final content, FIG. 2E. One of skill in the art will understand that a plurality of users associated with the same or a different channel may create content in a similar fashion via GUI 183 accessed through the common web site 180.

The images of a content screen, may include a variety of multimedia elements. These elements may include visuals, text, graphical images, animation, video and audio. Using GUI 183, the user accesses applications, located at the design module 110, to insert visuals such as graphical and animated images stored as various file formats. The user may also insert graphical files from digital cameras or scanners. The video may include digital files from a video source such as a VHS tape recording of community meetings where the audio and video content of the tape is digitized and stored as an electronic file using means known to those skilled in the art. The visual, audio and video sources preferably include information content directed to local and national weather, traffic, employment, beach or ski conditions, and city, county, state and federal government information.

While creating a content screen using GUI 183, the user may also enter text comprising a programming code directing the player 150 to access an on-line content source 135, at a designated URL, and to fetch the content over the internet 130. The on-line content source 135 is an entity unaffiliated with the party delivering the content over the internet 130 from the design module 110 to the player 150, such as the user. It is also unaffiliated with the channel broadcasting the content as a video signal. The on-line content source 135 preferably includes content sources directed to weather, news, traffic, financial, airport, health, or entertainment information. The on-line content source 135 also preferably includes information sources issuing FEMA alerts, Ambler alerts, Red Cross requests, Homeland Security alerts, and NOAA warning.

The reporter module 145 also provides for inserting information into a content screen. The GUI 183 allows a user to modify the screen background, images, text, audio and music files on existing screens. The updated information is delivered to the player 150 via the internet 130.

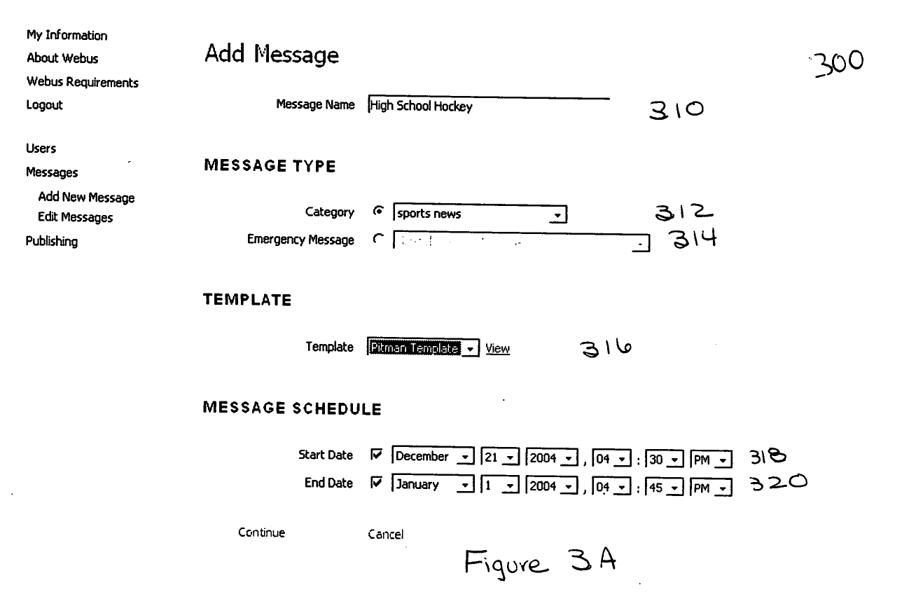

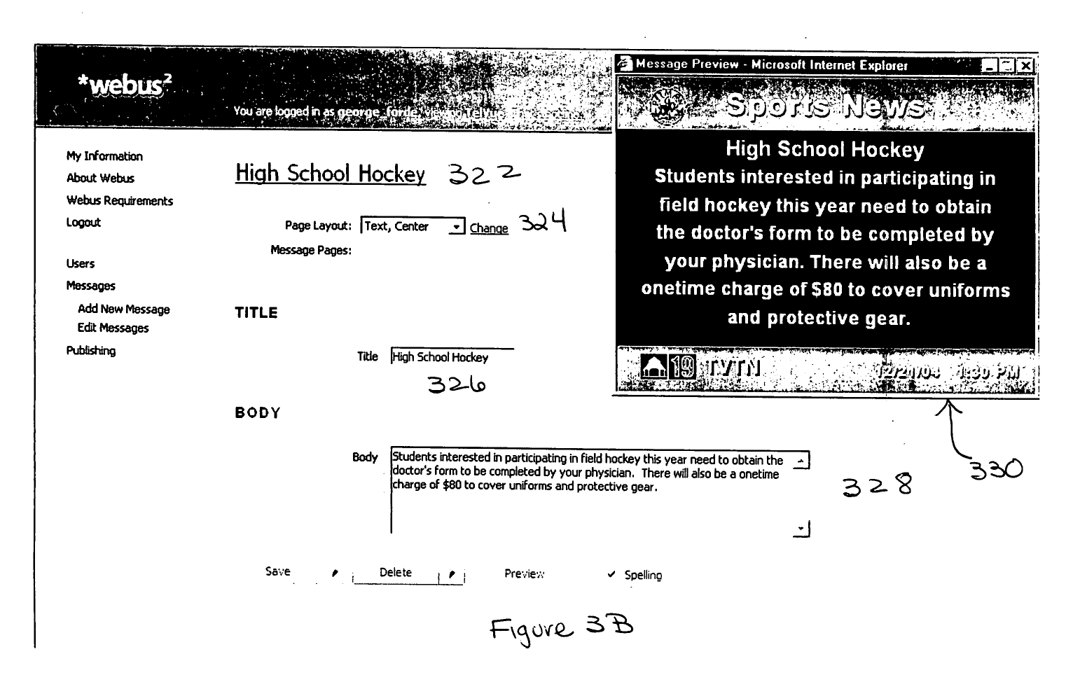

Once created, the content may be broadcast as a video signal from a channel affiliated with the user, displayed as a web page on a web site affiliated with the broadcast channel or broadcast as an audio message over a radio channel, as illustrated in FIGS. 3A-3D. The user creates a message, via GUI 183 using the Add Message screen 300 by entering the information in the message name field 310, wherein the message may consist of a variety of message categories 312 or an emergency message 314. In this exemplary illustration, the message format is defined by using a template selected in the template field 316. The user then schedules the time for broadcast of the message, over a channel, by entering the start date information 318 and the end date information 320. The user selects the page layout 324, the title 326 and the body text 328, FIG. 3B. A preview of the message 330 is shown then shown to the user for the user's approval. The content is then saved as an electronic file in the library 185 at the web server 184 and then is transmitted and stored at the player 150. The schedule server 120 delivers the electronic file to player 150. The message is then broadcast as a video signal by the player 150 over the channel 165 to the viewer display unit 170 based on the schedule input by the user affiliated with the channel. This is accomplished by the schedule server 120 sending a job file to player 150, where the job file is comprised of a list of files to be pulled down and played by the player 150

The method of the present invention provides for the real time updating of the visual, audio and video contents of the content where the content is fetched from an on-line content source 135 located on a server connected to the internet 130. As discussed above, the content may include screens with text containing programming codes. The content are delivered to the player 150, via the internet 130 as an electronic file, where the player is located at the cable system provider or client location. The player 150 stores the content as an electronic file. At a user-defined scheduled date and time, player 150 plays the content. When the player 150, reads a content screen containing text, comprising a programming code, directing the player 150 to URL of the designated on-line content source 135, it will automatically retrieve the updated content. The player 150 fetches the updated content by downloading the electronic screen, of on-line content source 135, to the player 150 and then delivering it to the cable headend 160 or LAN 172. The player 150 fetches the updated content of the on-line content source 135 each time it plays the content to the cable headend 160 or LAN 172. The content, including the updated content screen, is then broadcast as a video signal over a cable channel or video network such as a local area network.

In a second embodiment, the present invention is further directed to a method for accessing assembled content for publication of the assembled content over a communication media selected from the group consisting of an audio media, a video media and an audio-video media. With reference to FIG. 1, assembled content, stored in library 185 at web server 184, is provided wherein said assembled content is comprised of at least one of a single assembled content screen or a series of assembled content screens. The assembled content comprises at least one of visual information, video information and audio information plurality of users may access assembled content using the GUI 183 via the common web site 180. Each user is associated with a channel and each channel may have a plurality of associated users. One of skill in the art will understand that a plurality of users, associated with the same or a different channel, may access assembled content in a similar fashion via GUI accessed through the common web site.

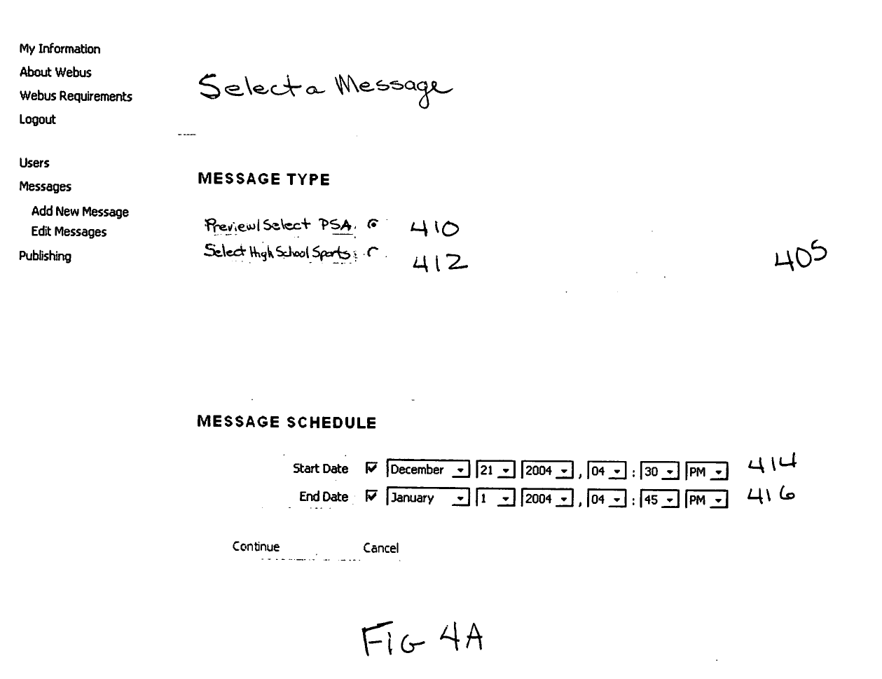

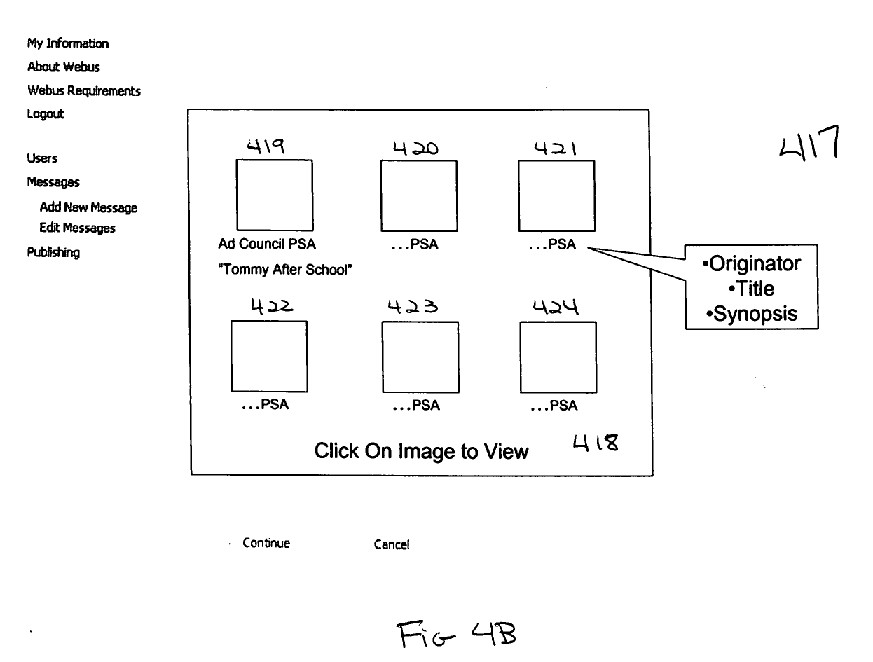

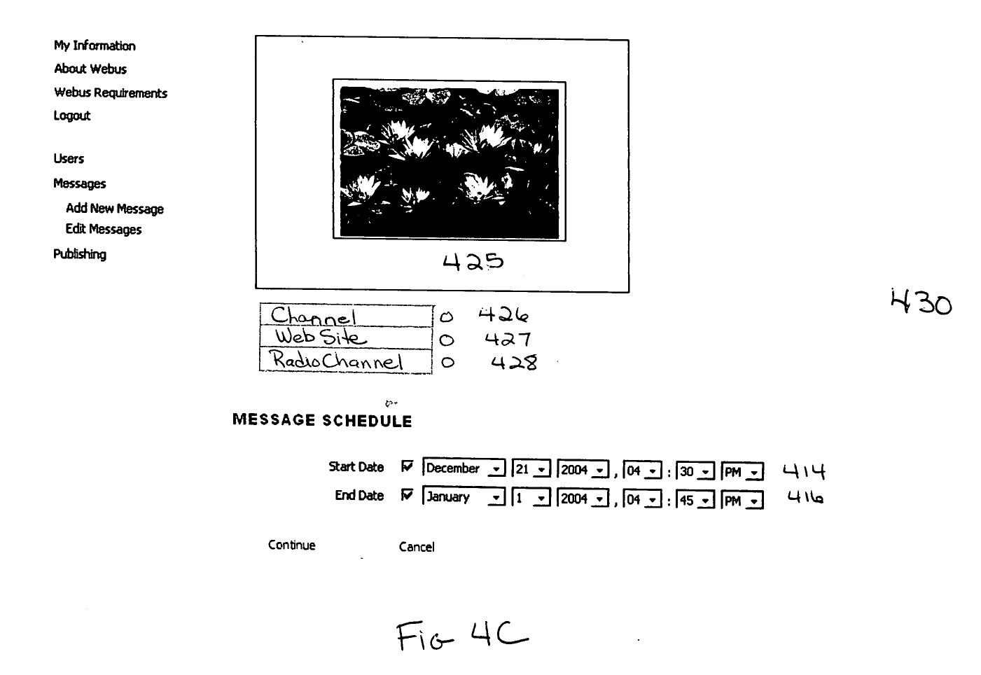

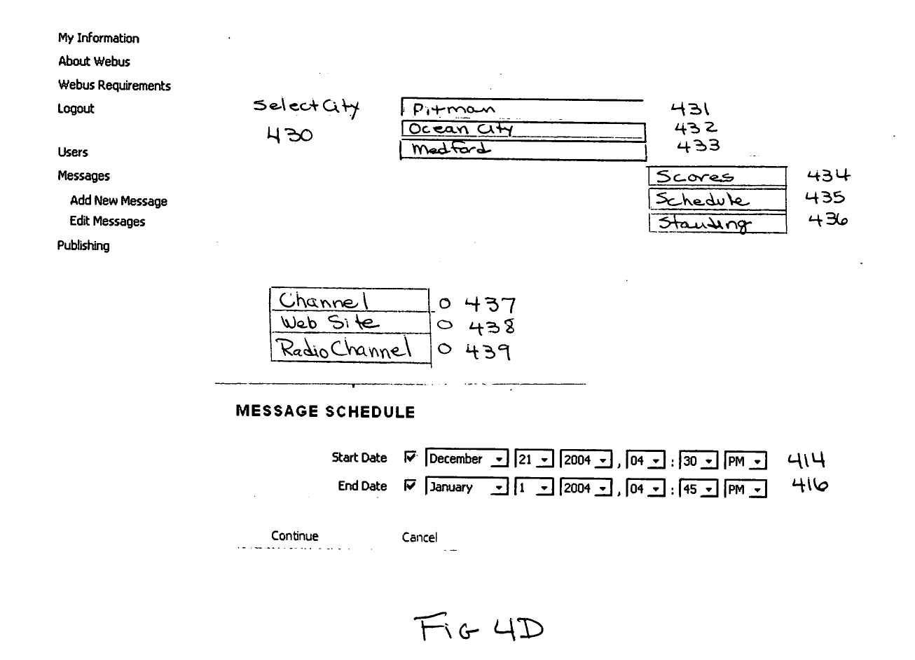

In a preferred embodiment, the assembled content is comprised of a plurality of public service announcements or a plurality of school sport data. As illustrated in FIG. 4A, GUI 405 allows a plurality of users to access assembled content, wherein the plurality of users access said GUI 405 through a common web site. A user selects, via GUI 405, a public service announcement 410 or school sport data 412 from the library. When the user selects a public service announcement, images of a plurality of public service announcements 419-424 are displayed, FIG. 4B. The public service announcement screen 418, displays the originator, title and a synopsis of each announcement. The user may click on an image 419, FIG. 4B, to preview the announcement 425, FIG. 4C. The user schedules, via the GUI 430, the selected assembled content for broadcast over a channel, associated with the user, wherein said channel comprises at least one of a cable channel or a video network. The user schedules the start date and time 414 and the end date and time 416 for broadcast of the assembled content, FIG. 4C. The assembled content, selected by the user, is sent, from the web server 184 via the internet 130, to a player 150. The assembled content, selected by the user, is broadcast as a video signal over the channel, associated with the user, in accordance with the scheduling performed by the user. A second user, via the graphical user interface, may select and schedule, for broadcast as a video signal over a channel, assembled content from the library, wherein the first user is not affiliated with the second user.

The user may also select school sport data for display as a video signal over a channel, at a web site affiliated with the channel. As illustrated in FIG. 4D, the user selects a city 430 from a drop down menu of choices, 431, 432 and 433. For the selected city, the user may then select for display of scores for school's sporting event 434, a schedule for the school's sport team 435 and the standing of the school's team within its league 436. The user may select for broadcast of the data as a video signal over a channel 437, as a web page 438 or as an audio message over a radio channel 439. The user then schedules the start date and time 414 and the end date and time 416 for broadcast of the data.

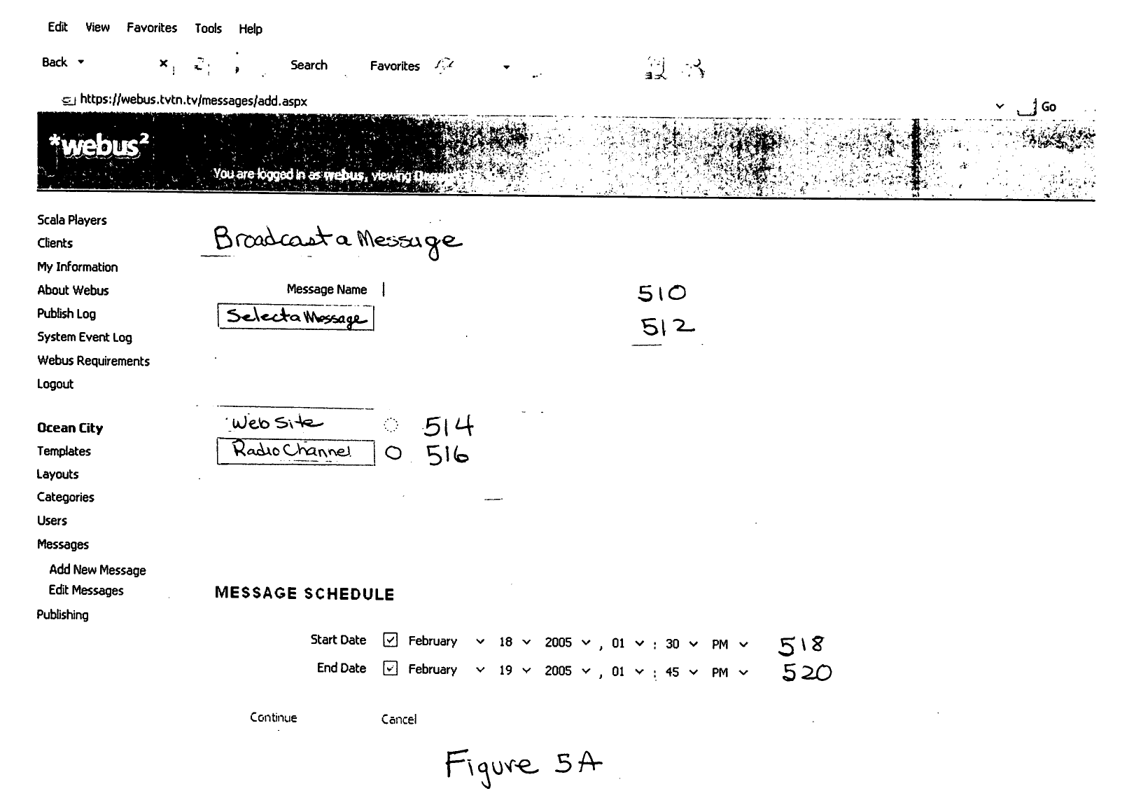

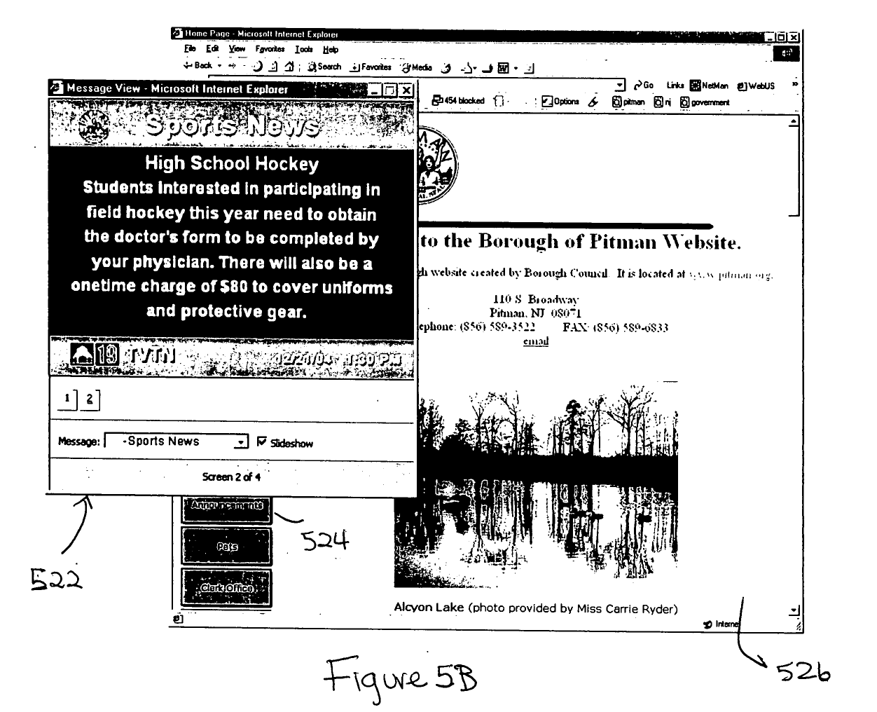

The created or assembled content may also be displayed as a web page on a web site or broadcast as an audio message on a radio channel, wherein both are affiliated with the user and the broadcast channel. For created content, it is saved as an electronic file, replicated and delivered to a library 185 at a web server 184 via the internet 130. For assembled content, it is stored in library 185 at web server 184. Using GUI 183, the user may select created or assembled content from the library 185 for display on a web site 186 wherein the user is affiliated with the broadcast channel 165. As illustrated in FIG. 4C, the user may broadcast the selected public service announcement 425 on a web site 427 or on a radio channel 428. As further illustrated in FIG. 5A, the user also select content for broadcast by entering a message name 510 or selecting a message from a drop down menu 512. The user may chose to broadcast the message by selecting a web site 514 or a radio channel 516. The user may also enter a schedule for broadcast of the message by entering the start date and time 518 and the end date and time 520. The home page 526 of the affiliated web site contains a hyperlink 524 to an associated web page 522. By clicking the hyperlink 524, the replicated content is delivered from the web server and displayed as a web page 522 at the web site. If the user selected to broadcast the message over a radio channel, the message is sent from the library 185 of the web server to a text to speech converter 188 where it is converted to an audio message. The message is then broadcast as an audio signal over a radio channel 190 associated with the channel 165, based on the user entered schedule.

The method of the present invention also provides for issuing an alert over a plurality of channels where the alert is posted on an electronic screen of an on-line source located on the internet 130. The channels include cable channels, over-the-air broadcast stations, direct broadcast satellite channels, and public and private closed circuit video networks. The alert preferably includes information from emergency information sources issuing alerts such as FEMA alerts, Ambler alerts, Red Cross requests, Homeland Security alerts, and NOAA warnings.

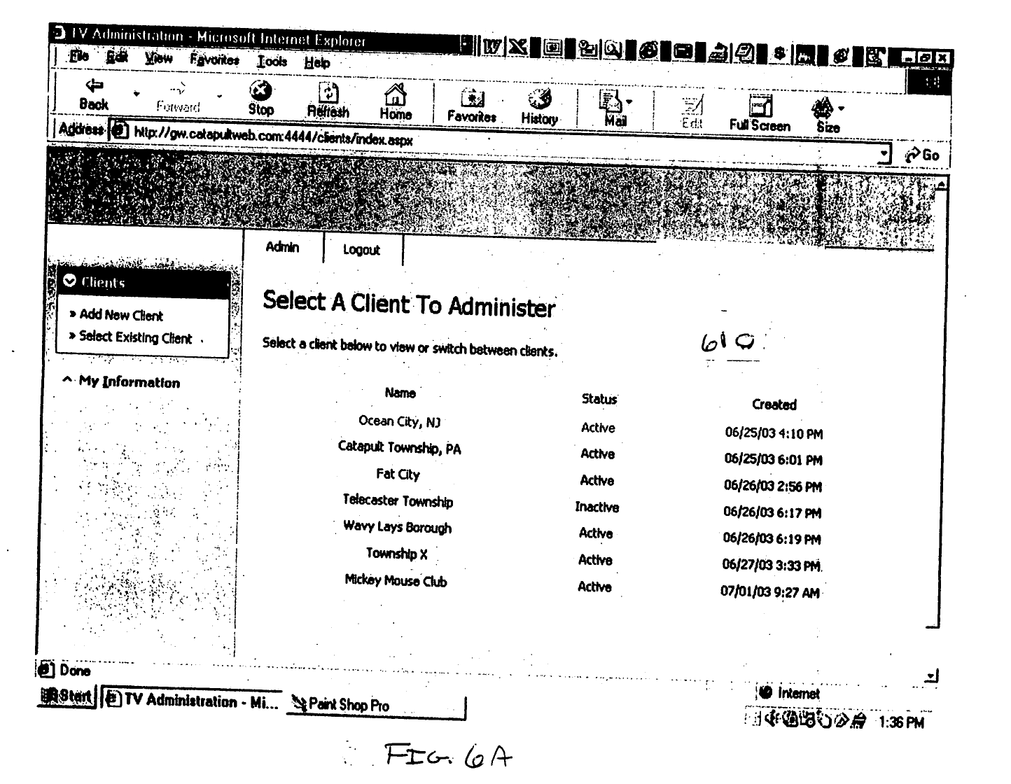

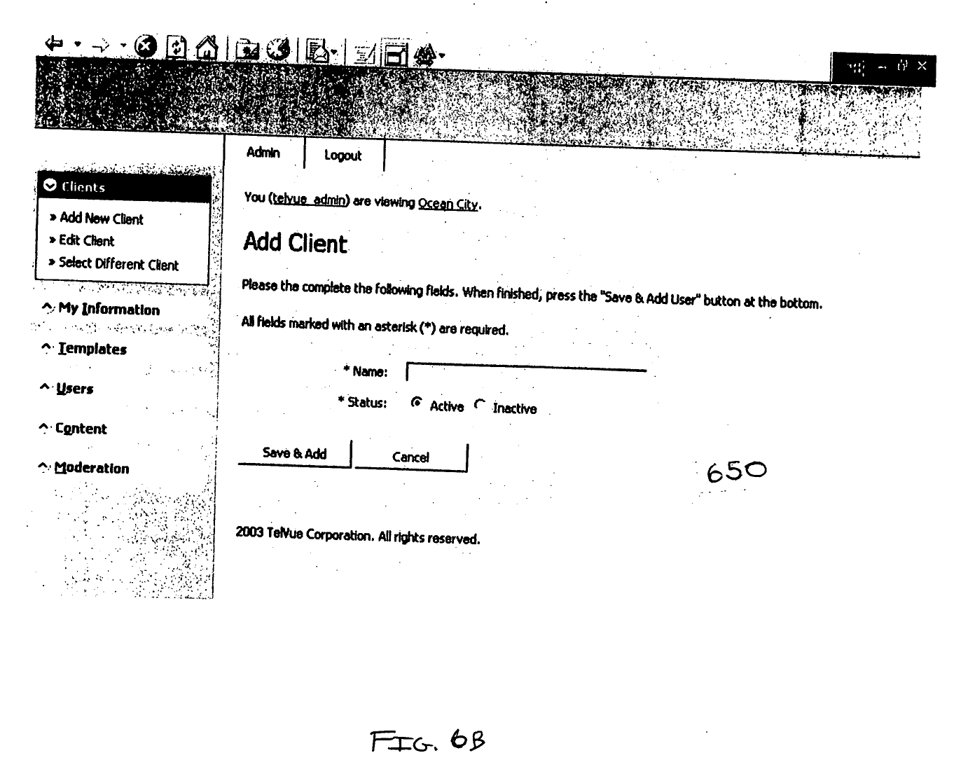

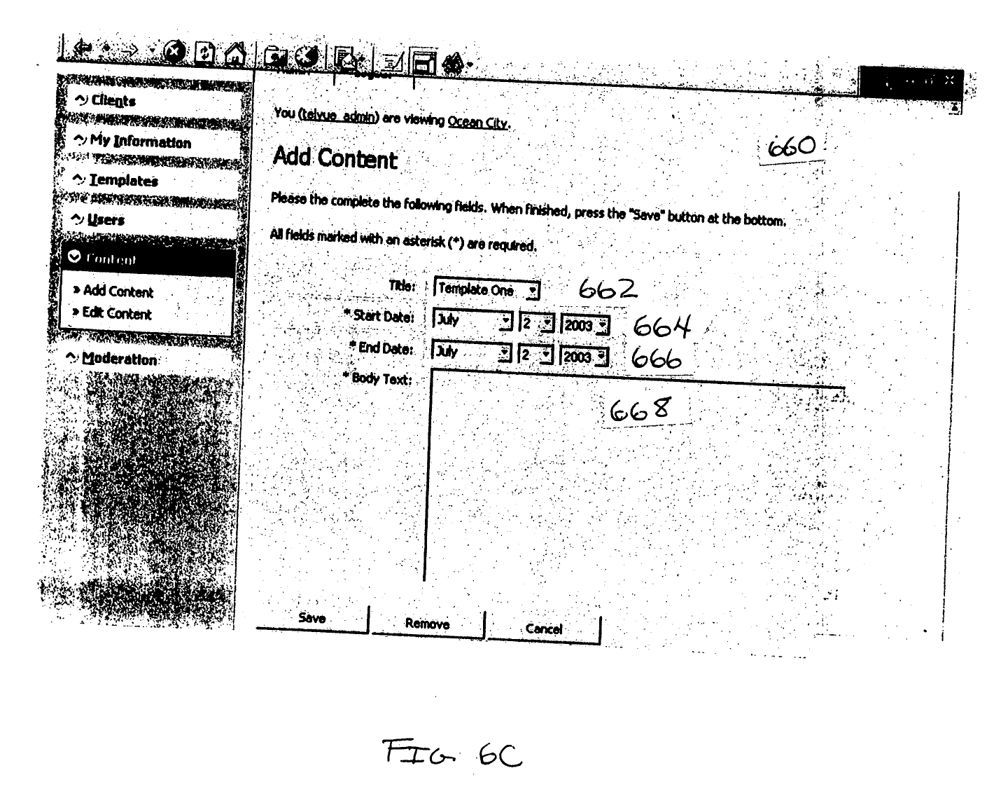

The method includes a web based graphical user interface, GUI2. It also includes a database that stores and organizes alerts and messages entered with GUI2. With reference to FIGS. 6A-6C, a GUI2, accessed on the user's browser, allows a user to enter an alert using a web browser located on the alert input unit 140. The method comprises multiple users and multiple clients. After logging into the system, the user selects the client to direct the alert information from the client administration screen 610, FIG. 6A. The client is comprised of entities that receive emergency notices such as city, county, state and federal government entities, elementary, secondary and post-secondary education entities and hotel, airport, shopping mall, sport venue and cruise ship lines. The user is at least one individual affiliated with an entity that maintains an on-line content source 135 that will issue an alert and post the alert on the internet 130. The user preferably includes employees of the entity issuing the alert or an individual with permission to enter alerts from the entity. Exemplary users include FEMA, federal, state and local governments, Red Cross, Department of Homeland Security and NOAA. The client menu screen allows the user to add, edit or select a different client using the client screen 650, FIG. 6B. The add content menu 660 allows the user to input an alert, FIG. 6C. The user may designate the title 662, the start date 664, the end date 666 and the text 668. Once the alert is created, the alert input unit 140 then sends the alert to an on-line content source 135 for display as an XML web page on the internet 130 or the broadcast over the cable channel.

Content, including screens with a programming code directed to on-line emergency information sources, are delivered to a plurality of players 150 at a plurality of channels, via the internet 130 as an electronic file. The plurality of players 150 read the programming code directing the players 150 to the URL of the designated on-line source. The on-line content source 135 will contain alert information if a user has entered an alert at the alert input unit 140 and delivered the alert through the internet 130 to the on-line content source 135. The plurality of players 150 then fetch the alert over the internet 130 by downloading the electronic screen of the on-line content source 135. The players 150 deliver the alert to the plurality of channels. The players 150 will fetch the alert from the on-line source each time it plays the content to the plurality of channels. If on-line source 135 contains no graphics, video, animation or audio, nothing is delivered to the plurality of players 150. The alert is then broadcast as a video signal over the plurality of channels.

The content, updated content and alerts are delivered over the internet 130 or a virtual private network. For delivery over a virtual private network, the content and alerts are encrypted at the user module 110 and alert input unit 140, respectfully. The content and alerts are then delivered over the internet 130 to the player 150. At the player, the encrypted content is decrypted and stored at the player for broadcast by the cable headend 160 or LAN 172.

With reference to FIG. 2E, an exemplary content is illustrated where the screens were created for broadcast over the government access channel of a cable service provider. Screens 1-5, 11-14 and 16-18 display local town news created from digital and graphical images and text of press releases and photos. Screen 6 illustrates a video presentation from a public service announcement. Screens 7-8 illustrate text messages displayed over graphical images announcing important community information. Screen 10 displays an Amber alert created by a government official at the alert input unit 140, delivered to an on-line source and then retrieved by the player 150 for broadcast. Screens 9, 15, 19, 36 and 43 contain audio information. Screens 21, 24, 26, 28 and 30 display weather information retrieved from the web servers of commercial weather services. Screen 35 displays real time traffic information containing live audio and video from a government traffic control agency or a commercial traffic information provider obtained from the entity's web server. Screens 37-42 and 43-48 displays graphics, video and audio content obtained from county, state and federal news. The user may input this information at the design module 110 or the player may fetch the information from the entity's web server. Screens 20, 22, 23, 25, 27, 29 and 31-34 display a blank screen. These screens are directed to electronic screens, on the internet 130, that currently do not contain any information. During subsequent broadcasts of the content, if information has been posted to the electronic screen, the information will appear on the content screen broadcast as a video signal over a cable channel.

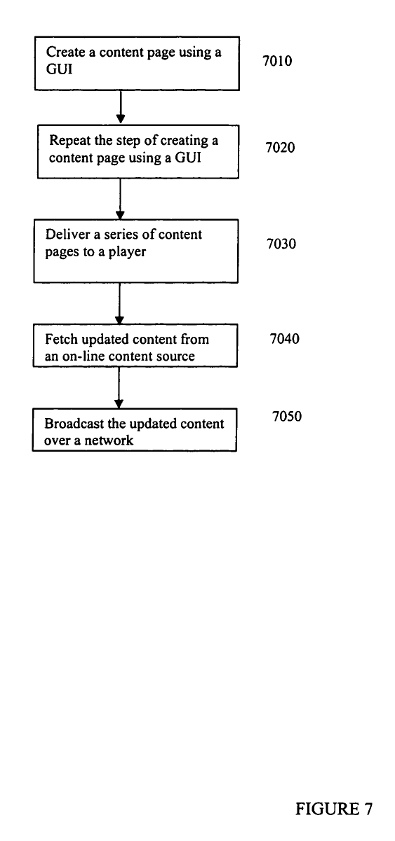

With reference to FIG. 7, a flow chart is shown illustrating a method of the present invention for creating a video signal, with updated information content, for broadcast over a channel. In step 7010, a content screen is created using a first graphical user interface. The content screen includes a programming code directed to an on-line content source. In step 7020, the step of creating a content screen is repeated in order to form a content. In step 7030, the content is delivered to a player located at a cable system provider or client location. In step 7040, the updated content is automatically forwarded to the player over the internet by fetching the updated content from the on-line content source and forming an updated content screen. The on-line content source is unaffiliated with the party delivering the content to the player nor is it the cable system. In step 7050, the updated content screen is broadcast as a video signal over the channel.

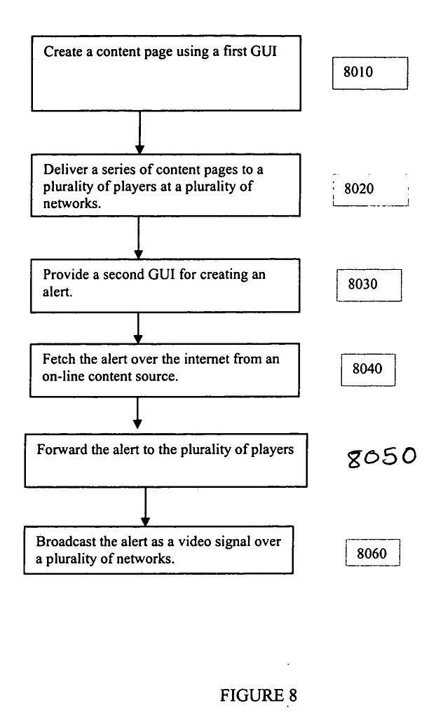

With reference to FIG. 8, a flow chart is shown illustrating a method of the present invention for issuing an alert over a plurality of channels selected from the group consisting of cable systems, over the air broadcast stations, direct broadcast satellite channels, and public and private closed video networks. In step 8010, a content screen is created using a first graphical user interface. In step 8020, a content is delivered to a plurality of players at a plurality of channels. In step 8030, a second graphical user interface is provided that allows a user, unaffiliated with a party performing the delivering or the plurality of channels, to create an alert. In step 8040, the alert is delivered to an on-line content source affiliated with the user. In step 8050, the alert is automatically forwarding to the plurality of players at the plurality channels, by fetching the alert over the internet from an on-line content source affiliated with the user. In step 8060, the alert is broadcast as a video signal over the plurality of channels.

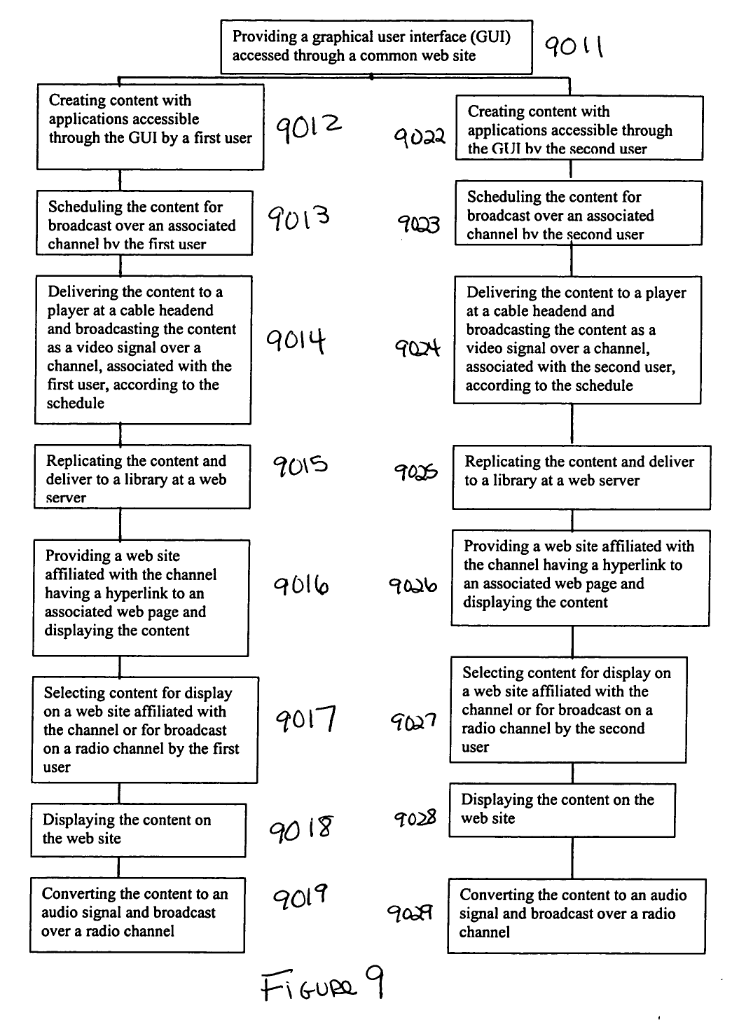

With reference to FIG. 9, a flow chart is shown illustrating a method of the present invention for creating content for publication of the content over a communication media selected from the group consisting of audio media, video media and audio-video media. In step 9011, a graphical user interface is provided that allows a plurality of users to create content. The plurality of users access said graphical user interface through a common web site. In step 9012, content, is created by a first user, using applications accessible through the internet via the GUI. In step 9013, the content, created by the first user, is scheduled for broadcast over a channel, associated with the first user. In step 9014, the content, created by the first user, is delivered to a player at a cable headend or client location and then broadcast as a video signal over the channel, associated with the first user, according to the scheduling input by the first user. In step 9015, the content is replicated and delivered to a library at a web server via the internet. In step 9016, a web site, affiliated with the channel, is provided having a homepage which includes a hyperlink to an associated web page. In step 9017, the content is selected for display on a web site or broadcast over a radio channel. In step 9018, the content is displayed as a web page on the channel affiliated web site. In step 9019, the content is converted an audio message and then broadcast as an audio signal over a radio channel. In steps 9022-9029, a second user performs similar steps for creating, selecting and scheduling content for broadcast as a video signal on a channel, display on a web page of an web site, or broadcast as an audio signal on a radio channel, each affiliated with the second user, wherein the second user is not affiliated with the first user.

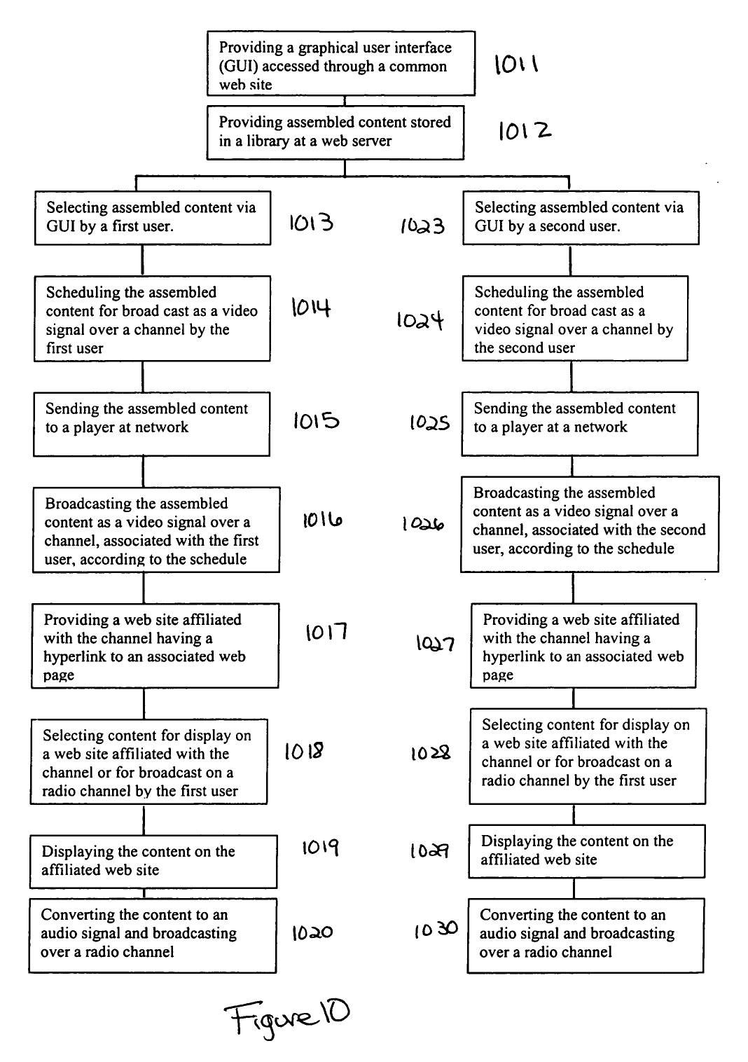

With reference to FIG. 10, a flow chart is shown illustrating a method of the present invention for accessing content for publication of the content over a communication media selected from the group consisting of audio media, video media and audio-video media. In step 1011, a graphical user interface is provided that allows a plurality of users to access assembled content, wherein the plurality of users access said graphical user interface through a common web site. In step 1012, assembled content, stored in a library at a web server. In step 1013, a first user selects, via the graphical user interface, an assembled content from the library. In step 1014, the first user schedules the assembled content for broadcast over a channel. In step 1015, the assembled content is sent, from the web server via the internet, to a player at a cable headend or client location. In step 1016, the assembled content is broadcast as a video signal over the channel, associated with the first user, according to the scheduling performed by the first user. In step 1017, a web site, affiliated with the channel, is provided having a homepage which includes a hyperlink to an associated web page. In step 1018, the content is selected for display on a web site or broadcast over a radio channel. In step 1019, the assembled content is displayed on the web page at the associated the web site. In step 1020, the assembled content may be sent to a text to speech converter, which converts the assembled content to an audio message which is broadcast as an audio signal over a radio channel. In steps 1023-1030, a second user performs similar steps for selecting and scheduling assembled content for broadcast as a video signal on a channel, display on a web page of a web site, or broadcast as an audio signal on a radio channel, each affiliated with the second user, wherein the second user is not affiliated with the first user

The present invention may be embodied in other specific forms without departing from the spirit or essential attributes of the invention. Accordingly, reference should be made to the appended claims, rather than the foregoing specification, as indicated the scope of the invention. Although the foregoing description is directed to the preferred embodiments of the invention, it is noted that other variations and modification will be apparent to those skilled in the art, and may be made without departing from the spirit or scope of the invention.

1. A method for creating content for publication of the content over a communication media selected from the group consisting of audio media, video media and audio-video media, comprising the steps of:
providing a graphical user interface that allows a plurality of users to create content,
wherein the plurality of users access said graphical user interface through a common web site;
creating a first content, by a first user, using applications accessible through the internet via the graphical user interface, wherein said first content is comprised of at least one of a first single content screen or a first series of content screens, comprising the steps of:
creating, by the first user, the first single content screen including at least on of:
defining a first picture size;
entering a first text;
inserting a first visual from a first visual source;
inserting a first video from a first video source;
inserting a first audio from a first audio source; and
assembling the first content screen in a digital format;
optionally repeating, by the first user, the step of creating a first plurality of single content screens in order to form the first series of content screens;
scheduling the first content, created by the first user, for broadcast over a channel, associated with the first user,
wherein said channel comprises at least one of a cable channel or a video network;
delivering the first content, created by the first user, to a player;
broadcasting the first content, created by the first user, as a video signal over the channel, associated with the first user, in accordance with the scheduling performed by the first user;
creating a second content, by a second user, using applications accessible through the internet via the graphical user interface, wherein said second content is comprised of at least one of a second single content screen or a second series of content screens, comprising the steps of:
creating, by the second user, the second single content screen including at least one of:
defining a picture size;
entering text;
inserting a visual from a visual source;
inserting a video from a video source;
inserting audio from an audio source; and
assembling the content screen in a digital format;
optionally repeating, by the second user, the step of creating a second plurality of single content screens in order to form the second series of content screens;
scheduling the second content, created by the second user, for broadcast over a channel associated with the second user,
wherein said channel comprises at least one of a cable channel or a video network;
delivering the second content, created by the second user, to a player; and
broadcasting the second content, created by the second user, as a second video signal over the channel, associated with the second user, in accordance with the scheduling performed by the second user.

2. The method of claim 1, further comprising:
replicating the first content;
delivering the replicated first content to a library at a web server via the internet;
selecting by the first user, via the graphical user interface, the replicated first content from the library;
providing a web site affiliated with the cable channel, associated with the first user, wherein a homepage of the affiliated web site includes a hyperlink to an associated web page;
fetching the replicated first content, selected by the first user, from the web server by clicking the hyperlink to the associated web page; and
displaying the replicated first content, selected by the first user, on the associated web page.

3. The method of claim 1, further comprising:
replicating the first content;
delivering the replicated first content to a library at a web server via the internet;
selecting by the first user, via the graphical user interface, the replicated first content from the library;
sending the replicated first content, selected by the first user, from the web server, to a text to speech converter;
converting the replicated first content, selected by the first user, to a first audio message;
scheduling, via the graphical user interface, the first audio message for broadcast over a radio channel, associated with the first user; and
broadcasting the first audio message as a first audio signal over a radio channel, associated with the first user, in accordance with the scheduling performed by the first user.

4. A method for accessing content for publication of the content over a communication media selected from the group consisting of audio media, video media and audio-video media, comprising the steps of:
providing assembled content stored in a library at a web server;
wherein said assembled content is comprised of at least one of a single assembled content screen or a series of assembled content screens;
wherein said assembled content comprises at least one of visual information, video information and audio information;
providing a graphical user interface that allows a plurality of users to access assembled content,
wherein the plurality of users access said graphical user interface through a common web site;
selecting by a first user, via the graphical user interface, an assembled content from the library;
scheduling, via the graphical user interface, the assembled content, selected by the first user, for broadcast over a channel, associated with the first user,
wherein said channel comprises at least one of a cable channel or a video network;
sending, from the web server via the internet, the assembled content, selected by the first user, to a player;
broadcasting the assembled content, selected by the first user, as a video signal over the channel, associated with the first user, in accordance with the scheduling performed by the first user;
selecting by a second user, via the graphical user interface, an assembled content from the library, wherein the first user is not affiliated with the second user;
scheduling, via the graphical user interface, the assembled content, selected by the second user, for broadcast over a channel associated with the second user,
wherein said channel comprises at least one of a cable channel or a video network;
sending, from the web server via the internet, the assembled content, selected by the second user, to a player;
broadcasting the assembled content, selected by a second user, as a second video signal over the channel, associated with the second user, in accordance with the scheduling performed by the second user.

5. The method of claim 4, further comprising:
providing a web site affiliated with the cable channel, associated with the first user, wherein a homepage of the affiliated web site includes a hyperlink to an associated web page;
fetching the assembled content, selected by the first user, from the web server by clicking the hyperlink to the associated web page; and
displaying the assembled content, selected by the first user, on the associated web page.

6. The method of claim 4, further comprising:
sending the assembled content, selected by the first user, from the web server, to a text to speech converter;
converting the assembled content, selected by the first user, to a first audio message;
scheduling, via the graphical user interface, the first audio message for broadcast over a radio channel, associated with the first user; and
broadcasting the first audio message as a first audio signal over the radio channel, associated with the first user, in accordance with the scheduling performed by the first user.
